(19) United States
(12) Patent Application Publication
(10) Pub. No.: US 2016/0261900 A1
(43) Pub. Date: Sep. 8, 2016

(54) SYSTEM AND METHOD FOR RENDERING OPTIMAL ROUTING IN VIDEO-ON-DEMAND NETWORKS

(71) Applicant: Wipro Limited, Bangalore (IN)

(72) Inventor: Manish Verma, Bangalore (IN)

(21) Appl. No.: 14/693,163

(22) Filed: Apr. 22, 2015

(30) Foreign Application Priority Data
Mar. 3, 2015 (IN) 1029/CHE/2015

(51) Int. Cl. H04N 21/266; H04N 21/472; H04N 21/239

(52) U.S. Cl. CPC H04N 21/266; H04N 21/2393; H04N 21/47202

(57) ABSTRACT

Methods and systems for determining optimal routing in Video-on-demand (VOD) networks include receiving, at least one VOD title from one or more systems. One or more attributes associated with the at least one VOD title are identified. The one or more attributes are mapped with one or more pre-defined rules. An optimal media processing workflow route is determined from one or more workflows based on effects of the mapping.

This application claims the benefit of Indian Patent Application No. 1029/CHE/2015 filed Mar. 3, 2015, which is hereby incorporated by reference in its entirety.

### FIELD

This disclosure relates generally to media environment. More specifically, it relates to a system and method for rendering optimal routing in Video-on-demand networks.

### BACKGROUND

In the plethora of media services offered by various service providers and content providers, Video-on-demand (VOD) can be considered as one such exclusive service that is gaining rapid recognition and demand. VOD are systems which enable the viewers to opt a particular video/audio content on their personal need basis, rather than the viewer being required to wait for the broadcasting time. Unlike any other media processing, for VOD service, the titles offered as part of the catalogue by the multi service operators (MSO) need to be processed before being delivered to consumer equipment. Needless to say, the preparation of media content is an elaborate workflow constituting various backend servers and specialized devices like Transcoders, Quality Checker Nodes, Encryptors, Ingestors etc, wherein the media processing workflow is managed by Content Management System (CMS).

It is to be noted that, rapidly expanding volume of content and increasing array of media file formats specification has caused multi fold increase in Capital and Operating expenditure (Capex and Opex) of MSOs. Furthermore, MSOs are finding it increasingly difficult to manage sporadic peaks of titles being ingested into their system for processing while keeping the costs low. The MSOs can deploy multiple content processing workflows for preparation of VoD titles but the key challenges remains to be, how to ensure optimal utilization of these processing units and find an optimal route to push VoD Titles to these processing units for the preparation.

Thus, there is a need for a solution which can ensure optimal selection and routing of VoD titles being ingested into the CMS to media processing workflows, guaranteeing maximum coverage of data and returns on investments.

### SUMMARY

Certain embodiments of the present disclosure relate to a method, implemented by a traffic management computer or other specialized computing device, for determining optimal workflow route in the VOD networks.

In certain embodiments, the method may comprise receiving, by at least one traffic management computing device, at least one VOD title from one or more systems. Furthermore, the method may comprise identifying, by the at least one traffic management computing device, one or more attributes associated with the at least one VOD title. In addition, the method may comprise mapping, by the at least one traffic management computing device, the one or more attributes with one or more pre-defined rules. Moreover, the method may comprise determining, by the at least one traffic management computing device, the optimal workflow route from one or more workflows based on effects of the mapping.

Certain embodiments of the present disclosure also relate to a specialized computer device that determines the optimal workflow route in the VOD networks. The computer system may comprise a processor operatively coupled to a memory device. The processor may be configured to execute instructions stored in the memory device to perform operations. The operations may comprise receiving at least one VOD title from one or more systems. The operations may furthermore comprise identifying one or more attributes associated with the at least one VOD title. The operations may further comprise mapping the one or more attributes with one or more pre-defined rules. The operations may furthermore comprise determining the optimal workflow route from one or more workflows based on effects of the mapping.

Certain embodiments of the present disclosure also relate to a non-transitory, computer-readable medium storing instructions that, when executed by a processor device, cause the processor device to perform operations including receiving at least one VOD title from one or more systems. Furthermore, the operations may comprise identifying one or more attributes associated with the at least one VOD title. Further, the operations may comprise mapping the one or more attributes with one or more pre-defined rules. Furthermore, the operations may comprise determining the optimal workflow route from one or more workflows based on effects of the mapping.

Additional examples of advantages of this technology will be set forth in part in the following detailed description, and in part will be obvious from the description, or may be learned by practice of the present disclosure. The examples of the advantages of this technology may by way of example be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 illustrates an exemplary system overview of a media processing workflow of a VOD title, according to some embodiments of the present disclosure;

FIG. 2 illustrates a system for determining optimal routing in a VOD network, according to some embodiments of the present disclosure; and

FIG. 3 is a flowchart of an exemplary method for determining optimal routing in the VOD network, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

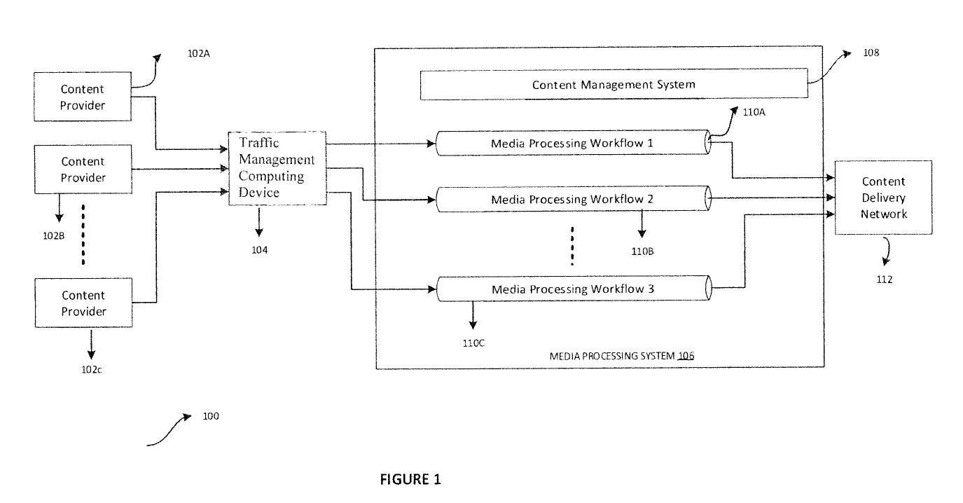

FIG. 1 illustrates an exemplary system 100 overview of a media processing workflow of the VOD title, according to some embodiments of the present disclosure. In this example, the system 100 may include one or more content providers. For example a content provider 102A, a content provider 102B and a content provider 102C. The one or more content providers are coupled to and in electronic communication with a traffic management computing device 104. Further, the traffic management computing device 104 is also coupled to and in electronic communication with a multi service operator system (MSO) 106. The MSO 106 includes a content management system (CMS) 108. The MSO 106 further coupled to a content delivery network CDN 112 enables in delivering of the VOD title received from the traffic management computing device 104 using one or more workflows, example a media processing workflow 110A, a media processing workflow 110B and a media processing workflow 110C. The delivering of the VOD title may be broadcasted or streamed over Internet Protocol.

In some embodiments, the one or more content providers and the CDN 112 can be considered as systems.

In some embodiments, the MSO 106 may also include one or more electronic devices or units for enabling media processing of the VOD title received from the traffic management computing device 104. For example, an ingestion client unit, one or more DMZ units, a quality checkers unit, an encryptors unit, a transcoders unit and a network attached storage (NAS) unit.

In one embodiment, the system 100 includes establishing a handshake, in response to the system 100 initialization, between the traffic management computing device 104 and the one or more content providers. The system 100 also establishes a handshake in response to the system 100 initialization between the traffic management computing device 104 and the MSO 106. In addition, system 100 also establishes a handshake in response to the system 100 initialization, between the traffic management computing device 104 and the CDN 112.

Further, the traffic management computing device 104 receives the VOD title from at least one content provider. The VOD title may include one or more attributes. For example, the one or more attributes may be title priority level, title quality level, input format, title enablement slot. The one or more attributes can be also considered as metadata associated with the VOD title. Thus, the traffic management computing device 104 is capable of identifying the one or more attributes associated with the VOD title.

Furthermore, the traffic management computing device 104 is capable of loading instances of the one or more workflows. Once, the one or more workloads are loaded, the traffic management computing device 104 is further capable of assigning the one or more workflows as primary workflow, secondary workflow and tertiary workflow based on configuration data. The configuration data may include but not limited to, input content formats of workflow, transcoding formats of workflow, encryption formats of workflow, per title processing cost of workflow, per title processing time of workflow, file based transcoding support of workflow, live transcoding support of workflow, proximity of workflow, processing quality level of workflow and weights for one or more pre-defined rules. Wherein the configuration data is pre-generated during handshake of the at least one traffic management computing device and the one or more systems. Further, the weights may be static or variable.

In addition, the traffic management computing device 104 is capable of loading the one or more pre-defined rules. The traffic management computing device 104 further, assigns a weight to each of the one or more pre-defined rules. The traffic management computing device 104 maps the one or more attributes associated with the VOD titles with each of the pre-defined rules. Further, the traffic management computing device 104 applies each of the pre-defined rules to each of the one or more workflows in order to assign the weight to each of the one or more workflows. The traffic management computing device 104 then sums all of the weights applicable to each of the workflows to determine a highest sum. The traffic management computing device 104 thus selects a workflow from the one or more workflows bearing the highest sum, as the optimal workflow route.

The traffic management computing device 104 also fetches additional metadata associated with the VOD title to derive a target output format. For example, the metadata may include inventory ID, Metadata ID, target output media format list and target output encryption format list. Thus, the traffic management computing device 104 initiates media processing of the VOD title into the optimal workflow route, in the target output format.

In some embodiments, the MSO 106 processes the VOD title via the optimal workflow route and delivers the content to the CDN 112. The CDN 112 further processes the content and enables to deliver the content to the consumer or the consumer premises equipment.

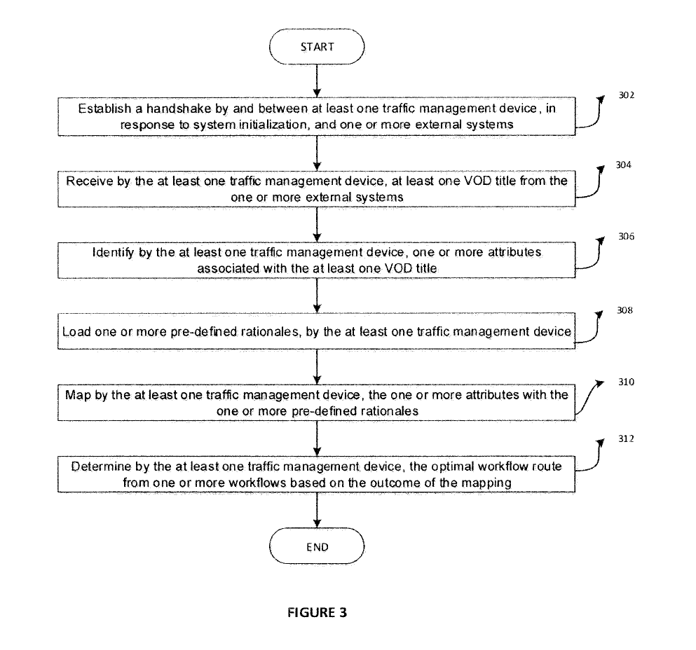

The method of selecting the optimal workflow route from the one or more workflows is well explained in conjunction with FIG. 3.

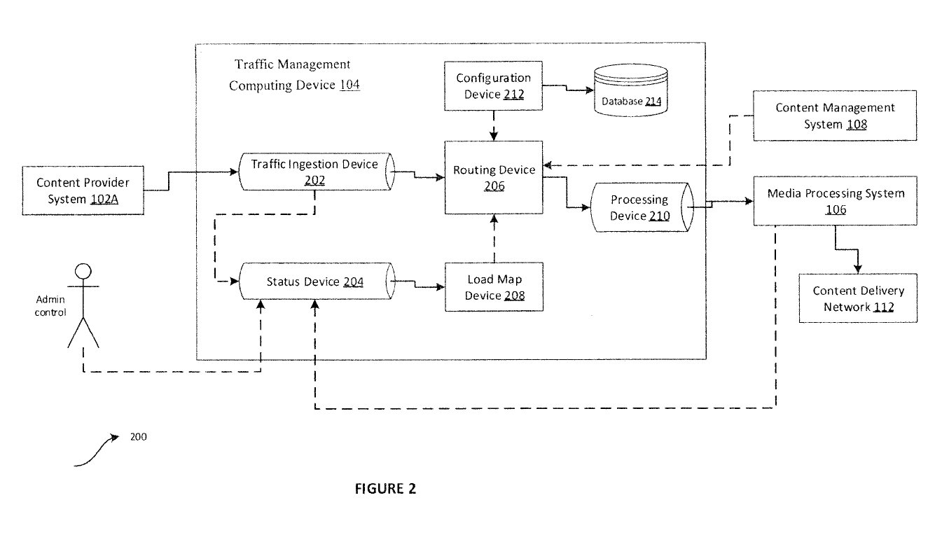

FIG. 2 illustrates a system 200 for determining optimal routing in the VOD network, according to some embodiments of the present disclosure. The traffic management computing device 104 includes a traffic ingestion device 202, coupled to a status device 204. The traffic ingestion device 202 is further coupled to a routing device 206, wherein, the routing device 206 is a processor. The status device 204 is coupled to a load map device 208. The load map device 208 is also coupled to the routing device 206. The routing device 206 is further coupled to a processing device 210 and a configuration device 212. The configuration device 212 is further coupled to a database 214. The processing device 210 is coupled to the MPS 106. The routing device 206 is coupled to the CMS 108.

The traffic management computing device 104 is the core engine and responsible to achieve the goal of optimal selection of the optimal workflow route and pushing of the VOD title into the optimal workflow route for media processing. The below description of devices and components of the system 200 explain the co-ordination between the devices and the components in achieving the goal of the traffic management computing device 104.

In one embodiment, the traffic ingestion device 202 receives the VOD title from the content provider 102A. The traffic ingestion device 202 is responsible for queuing the VOD title based on priority and requirement of the media processing. The traffic ingestion device 202 also electronically communicates with the status device 204 in order update the status of the one or more systems and the one or more workflows. The status updates from the status device 204 are further electronically received by the load map device 208.

In some embodiments, the status of the one or more systems and the one or more workflows can be controlled by a system administrator.

The load map device 208 further feeds the status update received from the status device 204 to the routing device 206. The load map device 208 is also responsible for monitoring the status of the one or more workflows and to update the status accordingly. The configuration device 212 manages the access to configuration data and provides interfaces for all the devices in the system 200 to access the configuration data. The configuration device 212 manages the one or more workflows configurations and the one or more pre-defined rules. The configuration device 212 also loads, updates and stores the one or more workflows configurations in the database 214. The database 214 stores all the configuration data and the one or more predefined rules. The processing device 210 is responsible for electronically communicating with the routing device 206 for queuing individual media processing workflows. This queue will be used by the routing device 206 to push the VoD title to appropriate workflow for further processing. This can be priority queue based on requirement.

Once the traffic ingestion device 202 receives the VOD title from the content provider 102A, it queues the VOD title based on the priority. Example, the VOD title may be on high priority compared to another VOD title. Thus, the traffic ingestion device 202 queues the VOD title first then the another VOD title for the media processing.

The routing device 206 receives the VOD title along with one or more attributes associated with the VOD title. The routing device 206 also receives the status of the one or more workflows, example the first workflow is processing 10 title, second workflow is processing 0 titles and third workflow is processing 15 titles. The status can include other details also. The details are well provided in conjunction with FIG. 3.

The routing device 206 also receives other status updates from the load map device 208. Thus, the routing device 206 collects all the status update to select the optimal workflow route for media processing of the VOD title. The routing device 206 collects the configuration data from the configuration device 212 and the database 214. The routing device fetches all the one or more attributes of the VOD title and maps the one or more attributes associated with the VOD title with each of the pre-defined rules. Further, the routing device 206 applies each of the pre-defined rules to each of the one or more workflows in order to assign the weight to each of the one or more workflows. The routing device 206 then sums up all of the weights applicable to each of the workflows to determine the highest sum. The routing device 206, thus selects the workflow from the one or more workflows bearing the highest sum, as the optimal workflow route.

The routing device 206 also fetches additional metadata associated with the VOD title to derive the target output format. Thus, the routing device 206 initiates media processing of the VOD title into the optimal workflow route, in the target output format via the processing device 210.

The method of determining the optimal workflow route for the VOD title received from the content provider 102A is well explained below in conjunction with FIG. 3.

FIG. 3 is a flowchart of an exemplary method for determining optimal routing in the VOD network, according to some embodiments of the present disclosure.

In some embodiments, at step 302, the handshake is established by and between the traffic management computing device 104, in response to system initialization, and the one or more systems.

At step 304, at least one VOD title is received by the traffic management computing device 104, from the one or more systems. Example, the at least one VOD title is “SHREK” from the content provider DISNEY_JUNIOR.

In some embodiments, there can be a check by the traffic ingestion device 202 to determine if a new VOD title is arrived from any content provider. If received, the new VOD title shall be sent to the routing device 206 else the check continues until the new VOD title arrives.

At step 306, the one or more attributes are identified by the traffic management computing device 104, associated with the at least one VOD title. The traffic management computing device 104 untars the at least one VOD title package and reads the metadata from the at least one VOD title package. Example, the one or more attributes associated with the at least one VOD title “SHREK” may be: priority level 2, quality level 2 and input MPEG2TS, Target Output formats (Video H.264, HEVC), (Audio—AAC, AC3, WMV), (Resolution—4K, 1080p, 720p), and no encryption needed.

At step 308, the one or more pre-defined rules are loaded by the traffic management computing device 104. The one or more pre-defined rules are stored in the database 214. The configuration device 212 enables the routing device 206 to fetch the one or more pre-defined rules from the database 214.

In some embodiments, the traffic management computing device 104 enables loading of the instances of the one or more workflows available for media processing.

The routing device 206 assigns the weights to the one or more pre-defined rules based on the configuration data. The routing device 206 also loads current state variables of the one or more workflows. Example but not limited to, processing capacity threshold, storage capacity threshold, current processing volume, active alert count, workflow reject count, admin control, ingestion queue count, current latency in the one or more workflows and current storage capacity.

At step 310 the traffic management computing device 104 maps the one or more attributes with the one or more pre-defined rules. Example, the one or more pre-defined rules may be:
1. For Priority 1 Vod Title, Processing Cost per title is less weighted factor than Processing Time per Title;
2. For Priority 2 Vod Title, Processing Cost per title is less weighted factor than Processing Time per Title;
3. For Priority 3 Vod Title, Processing Cost per title is more weighted factor than Processing Time per Title;
4. Priority 1 Vod Title needs to be processed by Primary Workflow System;
5. Quality Level 1 Vod title needs to be processed by Primary Workflow System;
6. Priority 2 Vod Title should not be processed by Tertiary Workflow System
7. Quality Level 2 Vod title should not be processed by Tertiary Workflow System;
8. Input format of the Title must be supported by the Workflow;
9. Target Transcoding format must be supported by the Workflow;
10. Target Encryption format must be supported by the Workflow;
11. File based Transcoding, Encryption and QC must be supported for NRT content;
12. Live Transcoding, Encryption and QC must be supported for Live Content;
13. One Title Processing must not be split between workflow systems;
14. Storage requirement for Target<Current available storage capacity;
15. Current Processing Queue<Threshold Processing Capacity;
16. Workflow is currently active and processing vod titles; and
17. If latency>=threshold, reduce primary rule weight by 50%.

The step 310 is well explained in conjunction with step 312.

At the step 312, the traffic management computing device 104 determines the optimal workflow route from the one or more workflows based on outcome (effects) of the mapping.

For example, considering there are three workflows deployed by the content provider 102A, wherein:
1. Workflow 1 is Primary
2. Workflow 2 is Secondary
3. Workflow 3 is Tertiary

It is to be noted that, the three workflows are assigned as the primary workflow 1, the secondary workflow 2 and tertiary workflow 3 based on the configuration data stored in the database 214.

Current Status update of the one or more workflows being:
1. Workflow 1 is processing 10 Titles (Max Capacity 15), supports all input, output formats, processing cost is 50$ per title, processing time 3 hrs;
2. Workflow 2 is processing 10 titles (Max Capacity 10), supports all input, output formats, processing cost is 30$ per title, processing time 2 hrs; and
3. Workflow 3 is inactive, supports all input, output format, processing cost is 20$ per title, processing time 2 hrs.

Once the one or more attributes associated with the VOD title “SHREK” are mapped with the one or more pre-defined rules (cited in the step 310), this example of the technology gets the below table values listing weights to each of the three workflows:

TABLE

| | Workflow | Workflow | Workflow |
|---|---|---|---|
| Pre-defined Rules | 1 | 2 | 3 |
| 1 | 0 | 0 | 0 |
| 2 | 0 | 2.5 | 5 |
| 3 | 0 | 0 | 0 |
| 4 | 0 | 0 | 0 |
| 5 | 0 | 0 | 0 |
| 6 | 5 | 5 | 0 |
| 7 | 5 | 5 | 0 |
| 8 | 5 | 5 | 5 |
| 9 | 5 | 5 | 5 |
| 10 | 5 | 5 | 5 |
| 11 | 5 | 5 | 5 |
| 12 | 5 | 5 | 5 |
| 13 | 5 | 5 | 5 |
| 14 | 5 | 5 | 5 |
| 15 | 5 | 0 | 5 |
| 16 | 5 | 5 | 0 |
| 17 | 5 | 0 | 5 |
| Total Weight | 60 | 52.5 | 50 |

The one or more attributes of the VOD title “SHREK” mentions that the VOD title is of priority level 2.

Hence, when mapping pre-defined rul 1 which mentions:

“For Priority 1 VOD Title, Processing Cost per title is less weight factor than Processing Time per Title” shall be ruled out. And thus, the weights for all the three workflows will be set to 0.

Now, when applying pre-defined rul 2 which mentions: “For Priority 2 Vod Title, Processing Cost per title is less weight factor than Processing Time per Title”, the workflow which is having least processing time per title shall be valued more, compared to the rest. Observing the processing times of the workflow 1, the workflow 2 and the workflow 3, it is evident that the workflow 1 is consuming more processing time compared to the rest i.e. 3 hrs. Since the processing times of the workflow 2 and the workflow 3 is only 2 hrs which is less than the processing time of the workflow 1 (i.e. 3 hrs), the weight of the workflow 2 and the workflow 3 shall be assigned to 5. Also, the weight assigned to the workflow 1 will be 0. This is one example wherein, the weight is static.

In some embodiments, the weight can be variable. For example, the pre-defined rul 17 mentions: “If latency>=threshold, reduce primary rule weight by 50%. Thus, while mapping the pre-defined rul 17, the primary rul weight being 5 will be reduced to 2.5 for the workflow which qualifies to fulfill the pre-defined rul 17. Assuming that the latency>=threshold for the workflow 2, the primary rul weight 5 (static) reduces to 2.5 (variable). As shown in the table. This depicts one good example of the weights being variable based on one or more preset conditions of the pre-defined rules.

Thus, when this process of mapping is continued for all of the one or more pre-define rules, this example of the technology ultimately obtains the values as distributed in the table.

In addition, the weights for each of the one or more workflows are added to obtain the highest sum. From the above values, in the table, this example of the technology illustrates that the workflow 1 has gained the highest sum of “60” compared to the workflow 2 and the workflow 3 having gained the sum of “52.5” and “50”.

Thus, the traffic management computing device 104 shortlists, the workflow 1 as the optimal workflow route for processing the VOD title “SHREK” in the target output format (Video H.264, HEVC), (Audio—AAC, AC3, WMV).

In some embodiments, the present disclosure: enables simultaneous processing of the one or more workflows for the media processing; optimally routes media content for parallel processing of the one or more workflows based on input variables; and provides feedback loop to gather system state variables which impact determining of the optimal workflow route.

The specification has described systems and methods for determining the optimal routing in the VOD networks. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for determining an optimal workflow route in a video-on-demand (VOD) network, comprising:
receiving, by at least one traffic management computing device, at least one VOD title from one or more systems;
identifying, by the at least one traffic management computing device, one or more attributes associated with the at least one VOD title;
mapping, by the at least one traffic management computing device, the one or more attributes with one or more pre-defined rules; and
determining, by the at least one traffic management computing device, the optimal workflow route from one or more workflows based on effects of the mapping.

2. The method of claim 1, further comprising:
loading instances of the one or more workflows, by the at least one traffic management computing device.

3. The method of claim 1, further comprising,
assigning the one or more workflows, by the at least one traffic management computing device, as primary, secondary and tertiary workflow based on configuration data, wherein the configuration data is pre-generated during handshake of the at least one traffic management computing device and the one or more systems.

4. The method of claim 1, further comprising:
monitoring, by the at least one traffic management computing device, the one or more workflows to update one or more state variables associated with the one or more workflows.

5. The method of claim 1, wherein the mapping comprises:
assigning, by the at least one traffic management computing device, one or more weights to each of the one or more workflows with respect to each of the predefined rules; and
summing, by the at least one traffic management computing device, the one or more weights for each of the one or more workflows.

6. The method of claim 5, further comprises:
selecting, by the at least one traffic management computing device, the optimal workflow route bearing the highest sum.

7. The method of claim 1, further comprising:
fetching, by the at least one traffic management computing device, additional metadata associated with the at least one VOD title to derive a target output format.

8. The method of claim 7, further comprising:
initiating, by the at least one traffic management computing device, media processing of the at least one VOD title, into the optimal workflow route, in the target output format.

9. A traffic management computing device, comprising:
at least one processor in electronic communication with at least one traffic management computing device; and
a memory storing instructions that, when executed by the at least one processor, cause the at least one processor to execute programmed instructions to:
receive at least one VOD title from one or more systems;
identify one or more attributes associated with the at least one VOD title;
map the one or more attributes with one or more pre-defined rules; and
determine the optimal workflow route from one or more workflows based on effects of the mapping.

10. The device of claim 9, wherein the memory stores programmed instructions that, when executed by the at least one processor, further cause the at least one processor to:
load instances of the one or more workflows.

11. The device of claim 9, wherein the memory stores programmed instructions that, when executed by the at least one processor, further cause the at least one processor to:
assign the one or more workflows as primary, secondary and tertiary workflow based on configuration data, wherein the configuration data is pre-generated during handshake of the at least one traffic management computing device and the one or more systems.

12. The device of claim 9 wherein the memory stores programmed instructions that, when executed by the at least one processor, further cause the at least one processor to:
monitor the one or more workflows in order to update one or more state variables associated with the one or more workflows.

13. The device of claim 9, wherein the memory stores programmed instructions that, when executed by the at least one processor, further cause the at least one processor to:
assign one or more weights to each of the one or more workflows with respect to each of the predefined rules; and
sum the one or more weights for each of the one or more workflows

14. The device of claim 13, wherein the memory stores programmed instructions that, when executed by the at least one processor, further cause the at least one processor to:
select the optimal workflow route bearing the highest sum.

15. The device of claim 9, wherein the memory stores programmed instructions that, when executed by the at least one processor, further cause the at least one processor to:
fetch additional metadata associated with the at least one VOD title to derive a target output format.

16. The device of claim 15, wherein the memory stores programmed instructions that, when executed by the at least one processor, further cause the at least one processor to:
initiate media processing of the at least one VOD title, into the optimal workflow route, in the target output format.

17. A non-transitory computer readable medium including instructions stored thereon that when processed by a processor cause a first computing device to perform acts of:
receiving at least one VOD title from the one or more systems;
identifying one or more attributes associated with the at least one VOD title;
mapping the one or more attributes with one or more pre-defined rules; and
determining an optimal workflow route from one or more workflows based on effects of the mapping.

18. The medium as claimed in claim 17, further comprising:
assigning one or more weights to each of the one or more workflows with respect to each of the predefined rules;
summing the one or more weights for each of the one or more workflows; and
selecting the optimal workflow route bearing the highest sum.

19. The medium as claimed in claim 17, further comprising:
fetching additional metadata associated with the at least one VOD title to derive a target output format; and
initiating media processing of the at least one VOD title, into the optimal workflow route, in the target output format.
